(19) United States
(12) Patent Application Publication
(10) Pub. No.: US 2026/0220731 A1
(43) Pub. Date: Jul. 30, 2026

(54) System and method for on-demand bodyguard services with dynamic, AI-driven risk assessment and tier recommendations

(71) Applicant: Guardly Corp., Miami, FL (US)

(72) Inventor: Veny Zorrilla, Miami, FL (US)

(21) Appl. No.: 19/449,769

(22) Filed: Jan. 15, 2026

Related U.S. Application Data
(60) Provisional application No. 63/749,885, filed on Jan. 27, 2025.

(51) Int. Cl. G06Q 50/26; G06Q 10/02; G06Q 10/0631

(52) U.S. Cl. CPC G06Q 50/265; G06Q 10/02; G06Q 10/063112

(57) ABSTRACT

Disclosed is a data-driven solution that combines modern mobile application technology with advanced risk assessment capabilities. Leveraging real-time location-based crime statistics and user-specific contextual factors, the system employs an AI-powered engine to dynamically assess risk. This risk is quantified into a low, medium, or high score, which is then mapped to three distinct tiers of bodyguards (G1, G2, and G3) based on their skills and experience levels.

### PRIORITY CLAIM

In accordance with 37 C.F.R. 1.76, a claim of priority is included in an Application Data Sheet filed concurrently herewith. Accordingly, the present invention claims priority to U.S. Provisional Patent Application No. 63/749,885, entitled “SYSTEM AND METHOD FOR ON-DEMAND BODYGUARD SERVICES WITH DYNAMIC AI-DRIVEN RISK ASSESSMENT AND TIER RECOMMENDATIIONS”, filed January 27, 2025. The contents of the above referenced application is incorporated herein by reference in its entirety.

### FIELD OF THE INVENTION

This invention is directed to the field of mobile software applications and security solutions. More specifically, the invention provides a method and system for hiring bodyguards on-demand while using real-time crime data, user profiles, and an AI-based risk assessment to recommend an appropriate tier of security personnel.

### BACKGROUND OF THE INVENTION

As personal safety becomes an increasing concern, there is a growing demand for on-demand bodyguard services. However, existing solutions often lack real-time risk assessment, efficient service selection, and seamless booking. The process of hiring qualified security personnel has traditionally been cumbersome and inefficient. It often involves contacting security agencies, manually verifying credentials, and scheduling services through phone calls or in-person consultations. This process is not only time-consuming but also lacks transparency and immediacy, leaving customers with limited information to make informed decisions. Moreover, customers typically do not have immediate access to a data-driven method to determine the level or type of security appropriate for their specific needs and situations, leading to uncertainty and inefficiency.

The problems addressed and rectified by this invention include 1) Real-Time Risk Determination wherein the dynamic nature of crime rates and contextual risks makes static methods of risk assessment, such as manual research or reliance on outdated data, inadequate for real-time decision-making; 2) Efficient Hiring wherein current solutions for hiring bodyguards require multiple steps, including manual availability checks, credential verifications, and scheduling arrangements, which can delay the deployment of security services during critical times; and 3) Appropriate Security Level wherein customers often lack the expertise to accurately assess their security requirements, leading to overestimation or underestimation of the level of security needed. Overestimation results in unnecessary costs, while underestimation compromises safety.

### SUMMARY OF THE INVENTION

Disclosed is a comprehensive on-demand bodyguard booking and dynamic risk assessment system. The system is designed to address inefficiencies and gaps in traditional security hiring processes. Based on a mobile application, the system is developed using a cross-platform framework such as Flutter, to enable users to request bodyguard services by specifying their location, risk factors, desired start time, and duration.

This disclosed system not only simplifies the hiring process but also ensures that users receive an appropriate level of security tailored to their unique circumstances. A decision-making module assures secure data handling, and flexible scheduling within a user-friendly mobile platform establishes a significant advancement in the field of on-demand personal security services.

A key feature of the system is its dynamic risk assessment component, powered by artificial intelligence. This module evaluates real-time, location-specific crime data alongside contextual factors such as time of day and user profile to compute a risk score categorized as low, medium, or high. Based on this score, the system recommends one of three tiers of bodyguards (G1, G2, or G3), each tailored to specific risk levels and characterized by varying skills and experience.

The system includes a bodyguard profiling and ranking mechanism. Bodyguards undergo comprehensive background checks, biometric data collection, and interviews. They also provide resumes, certifications, and other credentials. A machine learning algorithm ranks bodyguards according to their suitability for specific assignments or risk categories, ensuring optimal matching of personnel to user requirements.

A scheduling and payment module allows users to book bodyguards instantly or plan in advance, with a minimum booking duration of one hour. Additional time is prorated in 15-minute increments, providing flexibility and cost-effectiveness.

To ensure privacy and security, the system implements state-of-the-art measures for data protection, including SSL/TLS protocols for secure data transmission and AES-256 encryption for data at rest.

This invention revolutionizes the personal security industry by combining real-time data analysis, advanced AI, and secure technology to deliver tailored, efficient, and user-friendly bodyguard services. AI could assess the user’s environment in real-time (using data such as location, time of day, and recent local crime statistics) to recommend the level of protection required. For instance, in high-crime areas, the app might suggest Tier 3 bodyguards with extensive certifications and experience. For low-risk settings, Tier 1 bodyguards could be prioritized.

Another objective of the invention is to provide schedule optimization and availability prediction wherein an AI algorithm predicts the best available bodyguard based on user schedules and guard availability. The system may consider travel time, bodyguard workload, and recent jobs to ensure no one is overworked.

An objective of the invention is to modernize the personal security industry by offering a robust, scalable, and efficient system for hiring bodyguards based on real-time risk assessments, ensuring users receive the appropriate level of protection tailored to their needs.

Still another objective of the invention is the integration of AI-driven decision-making, secure data handling, and flexible scheduling within a user-friendly mobile platform which establishes a significant advancement in the field of on-demand personal security services.

Another objective of this invention is to simplify the hiring process but also ensure that users receive an appropriate level of security tailored to their unique circumstances.

Yet still another objective of this invention is to provide a user-friendly interface with transparent scheduling and payment processes.

Still another objective is to provide a secure and scalable infrastructure capable of future extensions, including wearables integration and predictive crime analysis.

An advantage of the invention is the seamless integration of real-time risk assessment and on-demand bodyguard hiring.

Another advantage of the invention is to provide AI-driven tier recommendations tailored to user needs.

Other objectives, benefits and advantages of this invention will become apparent from the following description taken in conjunction with any accompanying drawings wherein are set forth, by way of illustration and example, certain embodiments of this invention. Any drawings contained herein constitute a part of this specification, include exemplary embodiments of the present invention, and illustrate various objects and features thereof.

### BRIEF DESCRIPTION OF THE DRAWINGS

FIG. 1A is a flow diagram of the on-demand bodyguard booking and dynamic risk assessment system;

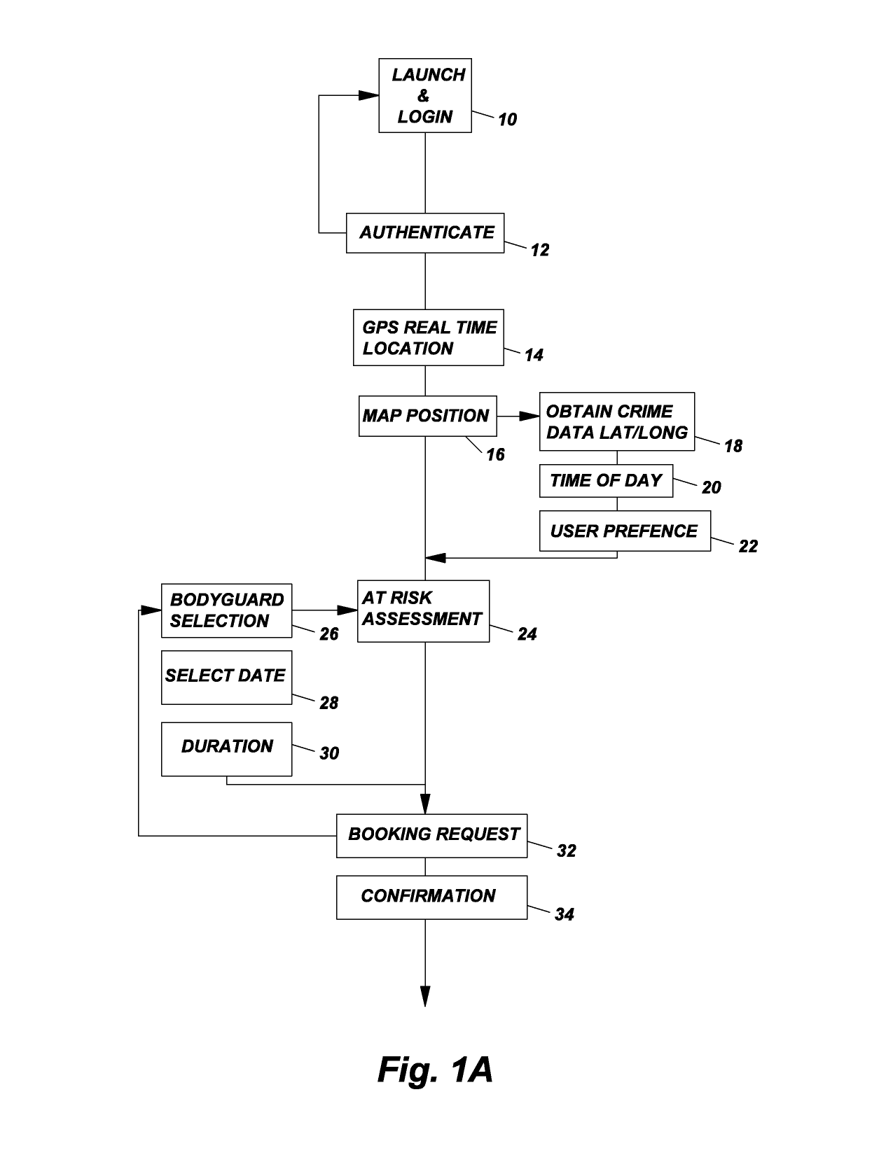

FIG. 1B is a continuation of FIG. 1A.

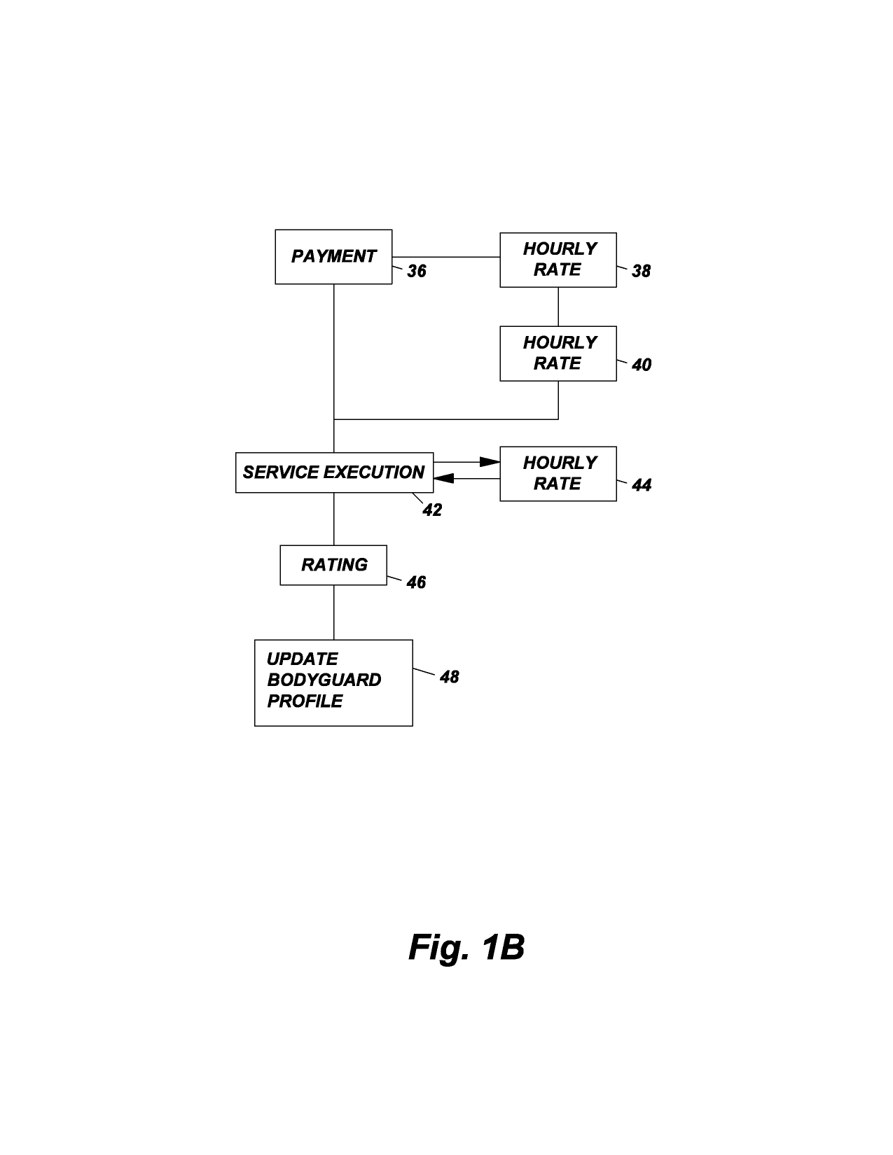

### DETAILED DESCRIPTION OF THE PREFERRED EMBODIMENT

It is to be understood that the disclosed embodiments are merely exemplary of the invention, which may be embodied in various forms. Therefore, specific functional and structural details disclosed herein are not to be interpreted as limiting, but merely as a basis for the claims and as a representation basis for teaching one skilled in the art to variously employ the present invention in virtually any appropriately detailed structure.

Disclosed is a streamlined, data-driven solution that combines modern mobile application technology with advanced risk assessment capabilities. Leveraging real-time location-based crime statistics and user-specific contextual factors, the system employs an AI-powered engine to dynamically assess risk. This risk is quantified into a low, medium, or high score, which is then mapped to three distinct tiers of bodyguards (G1, G2, and G3) based on their skills and experience levels.

The invention provides an integrated system for on-demand bodyguard booking and dynamic risk assessment. It addresses the inefficiencies of traditional security hiring by combining real-time crime analysis, AI-powered risk classification, and user-friendly scheduling within a secure mobile application framework.

The system architecture employs a mobile application front-end developed using Flutter for cross-platform deployment on iOS and Android which serves as the primary interface for users. It enables user authentication and login; viewing and selecting bodyguards from a ranked list; specifying location, start time, and service duration; and receiving dynamic risk-based tier recommendations.

A server back-end is built with Laravel (PHP) and hosted on AWS, to manage RESTful API communication with the front-end; user and bodyguard profile management; booking workflows and payment processing; and integration with external AI/ML components for risk assessment.

A MySQL database stores user profiles, including optional personal details and preferences; bodyguard profiles containing biometric data, certifications, resumes, and ratings; booking history and feedback records; crime data temporarily cached for analysis.

An AI/ML engine component aggregates: real-time location-based crime statistics via public APIs; contextual user data (e.g., time of day, risk tolerance); features such as crime density, severity, and environmental factors to compute a risk classification. The risk classification is mapped to one of three bodyguard tiers: G1 (low risk) - Licensed security; G2 (medium risk) - Armed security; G3 (high risk) - Law enforcement/military background with specialized skills.

Data collection for bodyguard profile creation and ranking is performed by comprehensive background checks, biometric data (fingerprints and facial scans), and detailed professional credentials, including resumes highlighting experience (e.g., law enforcement, military); certifications for armed or specialized security roles; physical attributes and unique skills (e.g., K9 handling). From the data collected, a profile is generated and compiled into structured database entries accessible to users through the app. A machine learning ranking model, such as a Random Forest Classifier, is used to evaluate factors like years of experience, certifications, and user feedback to assign a “strength score” to each bodyguard. This score is used for tier-based recommendations and to sort search results.

Dynamic risk assessment and tier recommendation requires real time input of location (GPS from user’s device); time of day (obtained from the phone or server); recent crime data (queried from a public crime API by region); and user profile (if user opts in, e.g., personal risk tolerance).

Feature extraction may include, but is not limited to; crime rate for last 7 days within a 2-mile radius; weighted crime severity factor (violent vs. non-violent); time of day (nighttime might have higher weighting); and user’s optional personal risk tolerance (if provided).

Risk Scoring & Mapping is provided through an AI engine that analyzes such features such as the following to compute a risk score. For instance, crime rate in the area within the last seven days; Severity of crimes (weighted higher for violent offenses); Environmental factors (e.g., nighttime higher risk).

A random forest classifier (example) with final classification outputs: “low risk,” “medium risk,” or “high risk.” In this example, if the score is “low” the system recommends G1; if “medium,” G2; if “high,” G3. The risk score can be used to bill at different rates: Low risk (G1) - $60/hour; Medium risk (G2) - $80/hour and High risk (G3) - $100/hour. The recommended tier is displayed on the ordering screen. The User can override and pick a different tier if so desired.

Referring to the Figures, an end-to-end process flow, from user launch to bodyguard acceptance comprises the following steps: User launch and login (10) ensures a secure and location-aware experience for the user. Authentication (12) confirms that the user is legitimate and prevents fake or duplicate accounts and ensures that all actions taken within the app are linked to a verified user, maintaining the integrity of app interactions. Preferably the system authenticates the user with backend servers using secure protocols such as OAuth 2.0 or equivalent. Complying with US privacy regulations, with potential for GDPR/CCPA compliance in the future. Encryption in Transit: SSL/TLS on all connections between the mobile app and server. Encryption at Rest: AES-256 for sensitive user data (e.g., personal info, location logs).

Real-time GPS data (14) updates the user’s location allowing for selection of guards within the area (iOS/Android). Geocoding will identify a city, district or street associated with the coordinates. Optionally this can share the user’s location for emergency services wherein an SOS button can be used to immediately dispatch local authorities or notify bodyguards in the area. Upon receipt of the GPS data, the user can adopt the GPS location chosen or enter/tap a location on an integrated map (16).

From the selected search location, an AI driven risk assessment is retrieved regarding the crime data based on lat/long coordinates (18), time of day (20), and user preferences (22). This allows the user to specify the type of crime data they want to monitor, such as kidnapping, theft, assault, vandalism, property crimes and so forth. AI can obtain crime data from various public and private sources. For instance, crime data can be instantly drawn from the RESTful APIs, FBI Crime Data, local police department databases, city-specific portals, neighborhood platforms, private data providers, and crowdsourced platforms. Data is parsed (JSON format typically) and stored temporarily in memory or a cache to feed into the AI engine all in real-time. The user can limit the radius of search to allow the user to define how far from their current location or selected position, they need to review. A tier recommendation for risk assessment (24) is selected for area based upon the crimes occurring within the area wherein the system proposes G1, G2, or G3 tiers. Low risk of crime in the area is assigned G1 tier, medium risk of crime in the area is assigned G2 tier, and a high risk of crime is assigned G3 tier. Location is constantly updated during the session to refine risk assessments and ensure the bodyguard can navigate to the user.

The system includes a machine learning model such as a random forest classifier with training data processing a historical data of crime rates, user safety incidents, and user feedback about risk levels. If not available at scale initially, the system can start with a rule-based approach and later transition to machine learning. For example, the inputs analyzed may comprise: Crime Density in the selected area over the past X days/weeks; Time of Day, categorical: morning/afternoon/evening/ late night), Crime Severity Factor (weighted index of violent crimes); User-Supplied Tolerance, if provided; Other Environmental Factors. The output classified into the aforementioned G1, G2 or G3 tier. Predictive crime trend analysis allows AI models using time-series forecasting to anticipate future hotspots or rising threat levels.

A bodyguard selection module (26) can further be filtered by a tier system. The user is presented with a list of available bodyguards (filtered by tier, or “Any”). The user selects a bodyguard profile, chooses a start time (28), and selected a duration (30) with a 1-hour minimum. AI could assess the user’s environment in real-time (using data such as location, time of day, and recent local crime statistics) to recommend the level of protection required. In high-crime areas, the system might suggest Tier 3 bodyguards with extensive certifications and experience, in low-crime areas the system could suggest Tier 1 bodyguards could be prioritized.

Booking request (32) is sent to the chosen bodyguard and, if the bodyguard accepts, the user gets a notification (push or in-app) (34). If denied, user sees “request denied” in the history screen. An AI algorithm can be used to predict the best available bodyguard based on user schedules and guard availability. The system could consider travel time, bodyguard workload, and recent jobs to ensure no one is overworked. For example, if a bodyguard just completed a long shift, they may not be prioritized even if they are closer in distance.

Payment and In-App management (36) includes payment calculated at the hourly rate (38) with 15-minute prorations if extended (40). The system can be configured to allow the user to cancel up to 1 hour before the scheduled start time without penalty. Service execution (42) takes place with the bodyguard and user meet at a specified location. The system monitors time (44) to calculate final fees. After the service, the user rates (46) the bodyguard, the ratings update the bodyguard’s profile in real time. Customer feedback analysis allows for continuous improvement. After every service, users can provide feedback and AI is employed to analyze this feedback to identify trends and improve future recommendations. For example, if users frequently mention good communication skills for a particular guard, AI could prioritize them for clients who value communication. Negative trends could trigger alerts for re-training or certification reviews for certain bodyguards.

The system allows for real-time incident reporting and support wherein the bodyguards are equip with AI-powered tools to analyze potential threats in real-time. For example, bodyguards could use AI-integrated camera tools to detect suspicious behavior or identify weapons in a crowd. The system can further provide real-time alerts to the client, such as “Potential threat identified near you; the guard is taking precautionary actions.”

The terms "comprise" (and any form of comprise, such as "comprises" and "comprising"), "have" (and any form of have, such as "has" and "having"), "include" (and any form of include, such as "includes" and "including") and "contain" (and any form of contain, such as "contains" and "containing") are open-ended linking verbs. As a result, a method or device that "comprises," "has," "includes" or "contains" one or more steps or elements, possesses those one or more steps or elements, but is not limited to possessing only those one or more elements. Likewise, a step of a method or an element of a device that "comprises," "has," "includes" or "contains" one or more features, possesses those one or more features, but is not limited to possessing only those one or more features. Furthermore, a device or structure that is configured in a certain way is configured in at least that way but may also be configured in ways that are not listed.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A system for on-demand bodyguard booking and dynamic risk assessment, comprising:
a mobile application, implemented in a cross-platform development framework, enabling users to specify location, desired start time, and duration for bodyguard services;
a risk assessment engine with machine learning that evaluates contextual factors, including but not limited to location-specific crime data, time of day, and user profile, to generate a risk score categorizing the user's request into predefined risk levels;
a bodyguard profiling system comprising: a database of bodyguard profiles including background checks, biometric data, industry certifications, and experience details; and a machine learning-based ranking algorithm to determine the suitability of bodyguards for specific risk levels;
a matching module configured to connect users with available bodyguards based on the specified parameters;
a scheduling and payment module configured to facilitate immediate or scheduled bookings, with minimum booking durations of one hour and incremental prorated extensions; and
wherein the system dynamically allocates bodyguards of varying skill and experience levels corresponding to the risk score.

2. The system for on-demand bodyguard booking and dynamic risk assessment according to claim 1 including a security and data protection framework employing secure communication protocols and encryption techniques to safeguard user data and location information.

3. The system for on-demand bodyguard booking and dynamic risk assessment according to claim 1 wherein said risk assessment module provides risk scoring and mapping to analyze features such as crime rate in the area within the last seven days and severity of crimes to formulate a risk score.

4. The system for on-demand bodyguard booking and dynamic risk assessment according to claim 1 including a random forest classifier to provide final classification outputs generated by AI.

5. The system for on-demand bodyguard booking and dynamic risk assessment according to claim 4 wherein said final classification outputs are designated as “low risk,” “medium risk,” or “high risk.”

6. The system for on-demand bodyguard booking and dynamic risk assessment according to claim 3 wherein an hourly rate is applied to each classification output generated by AI.

7. A method for providing on-demand bodyguard services, comprising:
a mobile application, implemented in a cross-platform development framework, enabling users to specify location, desired start time, and duration for bodyguard services;
an artificial intelligence-powered risk assessment engine, the method comprising:
i. receiving, from a user device, a request specifying a location and desired service time;
ii. querying a crime database for relevant location-specific data;
iii. iii. computing a risk classification using a machine learning model that incorporates the queried crime data, time of day, and user profile;
iv. mapping the computed risk classification to one of three predefined tiers of bodyguard based on skill and experience levels; and
v. transmitting the mapped recommendation to the user device for final selection;
a matching module configured to connect users with available bodyguards based on the specified parameters;
a scheduling and payment module configured to facilitate immediate or scheduled bookings, with minimum booking durations of one hour and incremental prorated extensions;
a security and data protection framework employing secure communication protocols and encryption techniques to safeguard user data and location information;
wherein the system dynamically allocates bodyguards of varying skill and experience levels corresponding to the computed risk classification.

8. The method for providing on-demand bodyguard services according to claim 7 including a bodyguard profiling system comprising a database of bodyguard profiles including background checks, biometric data, industry certifications, and experience details; and a machine learning-based ranking algorithm to determine the suitability of bodyguards for specific risk levels.

9. The method for providing on-demand bodyguard services according to claim 8 including classifying bodyguards into three tiers based upon qualifications.

10. The method for providing on-demand bodyguard services according to claim 7 including a step of employing secure communication protocols and encryption techniques to safeguard user data and location information.
